(19) United States
(12) Patent Application Publication
(10) Pub. No.: US 2026/0017501 A1
(43) Pub. Date: Jan. 15, 2026

(54) MODEL-CODE SEPARATION ARCHITECTURE FOR DATA COMPRESSION USING SUM-PRODUCT NETWORKS

(71) Applicant: Massachusetts Institute of Technology, Cambridge, MA (US)

(72) Inventors: Tejas Kumar Jayashankar, Plainfield, IL (US); Gregory W. Wornell, Wellesley, MA (US)

(73) Assignee: Massachusetts Institute of Technology, Cambridge, MA (US)

(21) Appl. No.: 18/880,914

(22) PCT Filed: Jun. 5, 2023
(86) PCT No.: PCT/US2023/067911

§ 371 Date: Jan. 3, 2025

Related U.S. Application Data
(60) Provisional application No. 63/370,576, filed on Aug. 5, 2022.

(51) Int. Cl. G06N 3/0495; G06N 3/0455; G06N 3/0464

(52) U.S. Cl. CPC G06N 3/0495; G06N 3/0455; G06N 3/0464

(57) ABSTRACT

According to some embodiments, a method of decoding data includes: receiving data compressed by a universal encoder and a data model based on a sum-product network (SPN) representing statistical structure inherent to source data, the source data corresponding to an uncompressed version of the data; and decompressing the data using the data model.

### CROSS-REFERENCE TO RELATED APPLICATIONS

This application claims the benefit under 35 U.S.C. § 119 of U.S. Provisional Patent Application No. 63/370,576 filed on Aug. 5, 2022, which is hereby incorporated by reference herein in its entirety.

### STATEMENT REGARDING FEDERALLY SPONSORED RESEARCH

This invention was made with government support under FA8750-19-2-1000 awarded by the Air Force Office of Scientific Research and CCF1816209 awarded by the National Science Foundation. The government has certain rights in the invention.

### BACKGROUND

The amount of data created every day is growing at an exponential rate. The storage and transmission of such data incurs significant costs. Compression can reduce costs by finding succinct representations to reproduce the data exactly or with very few distortions.

Compression systems can be divided into four domains depending on prior knowledge about the data and the metric for assessing the data reconstruction quality. Along one axis, systems can be divided based on the fidelity of reconstruction. If the reconstruction is perfect, i.e., the decoded output is the same as the input, the system performs “lossless” compression. On the other hand, “lossy” compression systems make a trade-off between compression rate and distortion to produce reconstructions that are perceptually “close” to the input. Savings are achieved by discarding bits from perceptually irrelevant regions. Along another axis, compression systems can be divided based on data model specificity. The “data model” captures all prior knowledge about the data source. This knowledge could be in the form of perceptual information or statistical information about the source. If the data model is specified, then the system is typically used for compressing specialized data. If the data model is not specified, then the system is typically used for compressing generic data, i.e., universal compression. Since a data model is required for compression, these systems learn statistical structure on-the-fly from the source data (or “input data”).

Conventional compression systems typically consist of an encoder that encodes the data into a compact representation, and a decoder that reproduces the data with as few differences as possible. To operate, both the encoder and decoder typically use prior knowledge about the source data. However, when the entire compression architecture is designed for specialized data, the downstream system is tuned to specific architectural choices, which makes it inflexible to changes in knowledge of the data and to modifications in the architectural design. As a result, improvements to such systems generally require a significant overhaul of the entire architecture, which might also result in it losing compatibility with already compressed data.

### SUMMARY

The compression of data is achieved by identifying typical statistical properties and redundancies in the data. This information is called the “source model” because it models the statistical properties of the source from which the data is drawn. Shannon's source coding theorem, which lays the foundations of information/communication theory. defines the “entropy” of a source as the lower bound on how much data can be compressed while reproducing the source exactly or with a specified distortion metric. The source model is a key component in any compression system and may be designed to match the entropy of the source.

Conventional compression systems may use tailored architectures for encoding data. The encoder of such a system uses the knowledge about the source model to transform the data into an intermediate representation in which the data is easier to code into a datastream. The datastream is a sequence of bits that is obtained using the intermediate features and the source model. The decoder parses this datastream to reproduce the data in the reverse process. This process is not automatic and the decoder must be endowed with information about the source model along with the coding mechanism. Once data is compressed using these systems, a change to the source model or coding mechanism generally requires an overhaul of both the encoder and decoder, making superior technology harder to adopt due to standardization and legacy reasons. An example of this is the JPEG-2000 standard which has still not completely replaced its 30-year-old predecessor, JPEG, despite demonstrating superior performance.

The design of compression systems for each data type can be costly and time-consuming. Thus, it is beneficial to develop so-called “model-code separation” technology whereby the encoding scheme is not tied to a particular source model and changes to the decoder do not affect the encoded representation.

With some existing model-code separation architectures, the encoder of the model “blindly” encodes the data using a universal encoding scheme into a succinct and potentially non-unique datastream. Note that the encoder is “free” of the source model. In the decoder, the datastream is used to recover a solution that agrees with the original data using knowledge about the source model and is therefore “model-adaptive.” Such architectures may use a graphical model to describe statistical structure in the source and may be limited to work with data for which the source graphical model is known. Learning a graphical model to model arbitrary sources is generally difficult due to intractability of learning algorithms and due to the potentially large size of these models, which in turn leads to suboptimal compression performance.

Advancements in distributed processing and inference on GPUs has resulted in a shift towards computational heavy decoders and lightweight encoders. For example, data from sensors must be communicated with a lightweight encoder due to the low hardware capabilities of such systems. The datastream can subsequently be decoded on fast processors, such as those available on smartphones, to reproduce the data.

Disclosed herein are systems and methods to address shortcomings of conventional compression systems by utilizing a data model based on sum-product networks (SPNs) to learn source “knowledge” from the data, as well as using SPNs for inferential decoding. SPNs are (deep) machine learning models for learning statistical structure in data, used here to address the learning problem in graphical models. The resulting system is adaptable to different data types, is highly modular and easy to deploy on optimized hardware. Disclosed systems and methods may be used for storage and communication of big data and may be implemented within architectures for compression of images, text, audio, genomics data etc. Disclosed embodiments defer all the assumed knowledge of the data to the decoder without loss in compression efficiency. The technology introduces a flexible system and set of algorithms to compress generally any type of data

Disclosed embodiments combine an SPN with modern error correcting codes to use iterative decoding algorithms to solve the data compression decoding problem. Methodology described herein extends the ideas of iterative decoding on graphical models to SPN source models implemented as deep learning architectures, thus bridging the gap between traditional statistical inference algorithms and modern machine learning models. Also described is a machine learning methodology that allows for improvements in compression performance as source modeling capabilities evolve in the future.

Techniques described herein allow the source model to be adjusted to match the computational load at the decoder, depending on the hardware capabilities of the receiver. Disclosed embodiments can be used in environments with computationally lightweight encoders (e.g., sensors) and computationally heavy decoders (e.g., GPU-enabled smartphones). Systems described herein are modular and easily modified. For example, improvements in modeling the source only require a redesign of the data model used in the decoder without change to the coding mechanism. Moreover, the same source model can be used for both lossless and lossy compression of data sources by the introduction of an additional modular component to model distortion in decoding.

According to one aspect of the disclosure, a method of decoding data can include: receiving data compressed by a universal encoder and a data model based on a sum-product network (SPN) representing statistical structure inherent to source data, the source data corresponding to an uncompressed version of the data; and decompressing the data using the data model.

In some embodiments, the method can further include: receive a coding transform associated with the compressed data; and generating a code graph representing the coding transform, wherein the decompressing of the data uses both the data model and the code graph. In some embodiments, the method can further include generating a combined graph having the data model, the code graph, and a virtual controller having nodes representing symbols in a sequence of the source data, wherein the decompressing of the data uses the combined graph.

In some embodiments, the decompressing of the data can include running belief propagation (BP) on the combined graph to compute approximate marginals of the source data sequence that satisfies constraints of both the data model and the code graph. In some embodiments, the running of BP on the combined graph may include passing, by the virtual controller, statistical information between the code graph and the data model. In some embodiments, the statistical information can be defined over a binary alphabet and the method may further include translating, by the virtual controller, the statistical information from the binary alphabet to an alphabet over which the compressed data is defined.

In some embodiments, the decompressing of the data can include losslessly recovering the uncompressed data. In some embodiments, the decompressing of the data may include lossily recovering the uncompressed data. In some embodiments, the model can be based on a deep generalized convolutional SPN (DGCSPN).

According to another aspect of the disclosure, a decoder for use in a data compression system with model-code separation may include one or more processors configured to perform said method embodiments.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 shows an example of a data compression system and architecture with joint model-code architecture.

FIG. 2 shows an example of a probabilistic graphical model (PGM), referred to as a factor graph.

FIG. 3 shows an example of a Tanner graph representing a low density parity-check (LDPC) matrix.

FIG. 4 shows an example of a sum-product network (SPN) that can be used for data compression, according to some embodiments of the present disclosure.

FIG. 5 shows an example of a deep generalized convolutional SPN (DGCSPN) that can be used for data compression, according to some embodiments.

FIG. 6 shows another example of an SPN that can be used for data compression, according to some embodiments.

FIG. 7 shows an example of a data compression system and architecture with model-code separation, according to some embodiments.

FIG. 8 shows an example of a combined source-code decoder that may be used within the system and architecture of FIG. 7.

FIG. 9 shows another example of a combined source-code decoder that may be used within the system and architecture of FIG. 7.

FIG. 10 shows an example of a combined SPN source-code decoder that may be used within the system and architecture of FIG. 7, according to some embodiments.

FIG. 11 illustrates a process for decompressing data that may be used with model-code separation systems and architectures, according to some embodiments.

FIG. 12 is a block diagram of a processing device on which methods and processes disclosed herein can be implemented, according to some embodiments of the disclosure.

The drawings are not necessarily to scale, or inclusive of all elements of a system, emphasis instead generally being placed upon illustrating the concepts, structures, and techniques sought to be protected herein.

### DETAILED DESCRIPTION

### Joint Model-Code Architectures

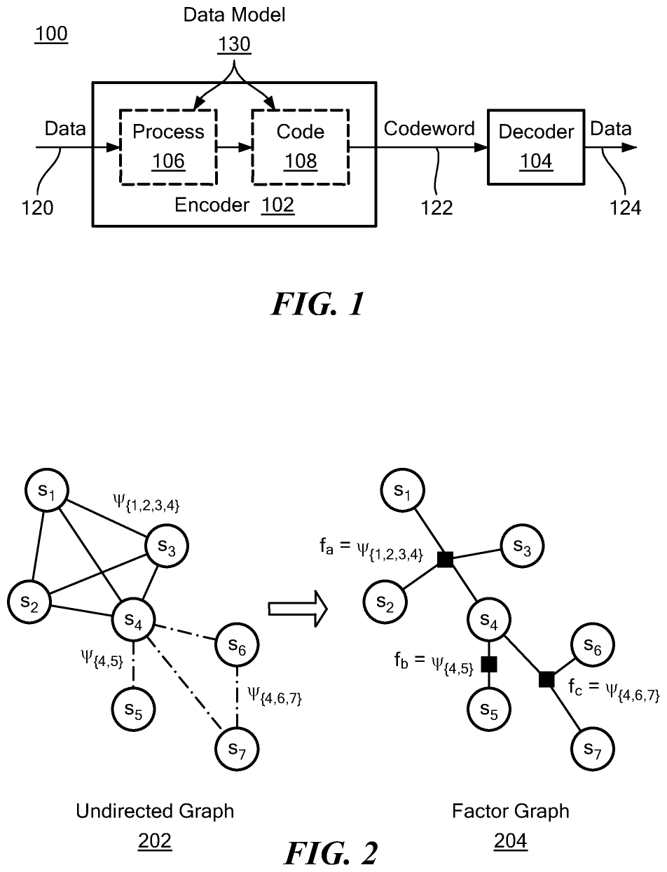

Turning to FIG. 1, many existing data compression systems (or “compressors”) employ a joint model-code architecture. An illustrative compression system 100 can have an encoder 102 and a decoder 104. Encoder 102 receives source data 120 and generates a compressed 122 version of the data as output. The compressed data 112 may be stored to non-volatile computer memory, transmitted over a computer network, etc. Decoder 104 receives the compressed data 122 as input and generates reproduced data 124. In the case of lossless compression, the reproduced data 124 is identical to the source data 120.

Illustrative encoder 102 includes a data processor 106 and a coding mechanism (or “codec”) 108. As shown, with a joint model-code architecture, the encoder 102—or more specifically coding mechanism 108—employs a model 130 of the source data 120. For example, in the case of Huffman Coding, data processor 106 can learn the data model 130 by building a binary tree that stores the frequency of symbols that appear in the source data. The construction of the binary tree can be referred to as “processing” the data. The coding mechanism 108 uses the data model 130, i.e., the frequencies of the symbols, to efficiently compress the data by assigning smaller length binary codes to more frequently occurring symbols and assigning larger length codes to less frequently occurring symbols. It has been shown that Huffman Coding achieves entropy and is the optimal code choice for a given data model. However, if the data model 130 changes, the previously learned code may be sub-optimal. Moreover, the data model 130 and the coding mechanism 108 must generally be learned for every new instance/type of source data 120. Similar drawbacks exist for other compression standards and systems that do not employ “model-code” separation.

### Notation

Certain notation used throughout this disclosure is now introduced.

s denotes a random variable and s denote a scalar variable. To denote a length n random vector or a sequence of n random variables, the notation sⁿ is used. The i′th element of sⁿ is denoted as sᵢ. Depending on the situation, sⁿ may be written as a column vector [s₁ s₂ . . . sₙ]^{T} or as a sequence (s₁, s₂, . . . , sₙ). sⁿ and sᵢ (lowercase) denote the non-random version of the same.

As examples, H is reserved for a matrix and [symbol] for a set. H^{j} denotes the vector representing the j′th row of H. 1 is used to denote the vector of all ones. The notation

$${x}_{j}^{r}$$

is sometimes used to denote j′th length r vector in the block vector

$${x}^{kr} = [ \begin{matrix}{x}_{1}^{r} & {x}_{2}^{r} & … & {{x}_{k}^{r} ]}^{T} .\end{matrix}$$

Graphical models are sometimes used herein to represent probability distributions. An undirected graph is represented by [symbol] =( [symbol] , [symbol] ) where [symbol] is the vertex/node set and [symbol] is the edge set. If a graph [symbol] represents the distribution pₛ_{ⁿ}, then [symbol] is set to [symbol] ={1, . . . , n} such that node v∈ [symbol] represents [symbol] . The shorthand [symbol] is used to denote sⁿ and [symbol] to denote sⁿ.

$${s}_{𝒜}^{n}$$

denotes indexing of a random vector sⁿ with the index set [symbol] . In the graphical model setting, the shorthand [symbol] is used. Similar notation may be used in the non-random setting.

Embodiments of the present disclosure relate to model-code separation systems, architectures, and techniques. A model-code separation architecture for data compression can be decomposed into two sub-components—1) a model-free code, a 2) the model-adaptive decoder. The fundamental concepts behind the model-free code come from the field of information theory, coding theory and communications. The development of the model-adaptive decoder draws inspiration from statistical inference and deep learning.

### Source Coding Theory

Communications and data compression can be viewed as statistical information theoretic problems. Shannon introduced two source-coding theories for lossless and lossy compression of data. The source coding theorem for lossless compression is stated next.

Given a random variable s˜pₛ belonging to a finite alphabet [symbol] , its entropy is defined as

$${H}_{p} ( s ) {=}^{Δ} - {\sum }_{s ∈ 𝒮} {p}_{s} ( s ) log {p}_{s} ( s ) . \qquad ( 2 )$$

The source coding theorem is now stated. Given a random variable s˜pₛ belonging to a finite alphabet [symbol] , for all uniquely decodable coding functions c: [symbol] → [symbol] , where [symbol] is the code alphabet, it holds that [symbol] [c(s)]≥Hₚ(s).

In other words, Shannon's source coding theorem for lossless compression states that a random variable s cannot be compressed into fewer than H(s) bits without information loss.

Given a sequence of random variables represented as a random vector sⁿ=[s₁, s₂, . . . , sₙ]^{T} with each sᵢ belonging to a finite alphabet [symbol] , the entropy rate of the sequence is defined as

$${ℍ}_{p} ( s ) {=}^{Δ} {lim}_{n \to ∞} \frac{1}{n} {H}_{p} ( {s}^{n} ) . \qquad ( 3 )$$

As mentioned above, the Huffman code is an example of a code which achieves entropy since it is designed specifically for the true source distribution pₛ_{ⁿ}(sⁿ). However, assuming that the coder was designed for some incorrect distribution qₛ_{ⁿ}(sⁿ), the Huffman code is no longer optimal for source sequences sⁿ˜pₛ_{ⁿ}. Disclosed structures and techniques allow for, with no knowledge about pₛ_{ⁿ}(sⁿ), the design of a so-called “universal code” with rate ru such that every independent and identically distributed (i.i.d.) source with entropy Hₚ(sⁿ)<rᵤ can be described. For ease of exposition, disclosed embodiments are described in terms of a particular class of universal codes.

By way of background, weakly typical sequences can be defined as follows. Let sⁿ=(s₁, . . . , sₙ) be a sequence drawn from pₛ_{ⁿ} over a finite alphabet [symbol] . The typical set [symbol] ⊂ [symbol] contains those sequences that satisfy,

$${2}^{- n ( {H}_{p} ( {s}^{n} ) + ϵ )} \leq {p}_{{s}^{n}} ( {s}^{n} ) \leq {2}^{- n ( {H}_{p} ( {s}^{n} ) - ϵ )} . \qquad ( 4 )$$

A fixed rate block code B(2^{nr}^{ᵤ}, n) of rate rᵤ for a source sⁿ which has an unknown distribution pₛ_{ⁿ} consists of two mappings, the encoder

$${f}_{n} : {𝒮}^{n} \to \{ 1 , 2 , … , {2}^{n {r}_{u}} \} , \qquad ( 5 )$$

and the decoder,

$${ϕ}_{n} : \{ 1 , 2 , … , {2}^{{nr}_{u}} \} \to {𝒮}^{n} . \qquad ( 6 )$$

The probability of error of the code with respect to pₛ_{ⁿ} is

$${P}_{ϵ}^{( n )} = ℙ \{ {ϕ}_{n} ( {f}_{n} ( {s}^{n} ) ) \neq {s}^{n} \} . \qquad ( 7 )$$

A formal definition of a universal fixed rate block code is now given. A rate rᵤ block code for a source is called universal if the functions fₙ and ϕₙ do not depend on the distribution pₛ_{ⁿ} and if

$${P}_{ϵ}^{( n )} \to 0 as n \to ∞ if {H}_{p} ( {s}^{n} ) < {r}_{u} .$$

As known in the art, there exists a sequence of universal codes B(2^{nr}^{ᵤ}, n) such that

$${P}_{ϵ}^{( n )} \to 0$$

for every source pₛ_{ⁿ} such that Hₚ(sⁿ)<rᵤ.

The encoder is defined by

$${f}_{n} ( {s}^{n} ) = \{ \begin{matrix}index of {s}^{n} in 𝒟 & if {s}^{n} ∈ 𝒟 \\ 0 & else\end{matrix} \qquad ( 8 )$$

$$where 𝒟 = \{ {s}^{n} : {s}^{n} ∼ {p}_{{s}^{n}} ( {s}^{n} ) with {H}_{p} ( {s}^{n} ) \leq {r}_{u} \} .$$

Of note, every element in [symbol] is decoded perfectly while elements with entropy larger than rᵤ are not. Thus shown is a definition universal coding scheme with fixed rate codes. In some cases, variable rate universal codes may be used for compressing generic data. The Lempel-Ziv algorithm which is used in GZIP compressors is an example of such a scheme.

### Probabilistic Graphical Models

Probabilistic Graphical Models (PGMs) are graphical models that can be used to compactly represent statistical structure and conditional (in)dependencies in data. In addition to modeling data, PGMs are capable of performing various inference tasks such as computing marginal distributions, sampling and computing moments.

An “undirected graphical model” refers to an undirected graph [symbol] =( [symbol] , [symbol] ) where each v∈ [symbol] represents a random variable and the edges represent conditional dependencies. If a family of probability distributions pₛ_{ⁿ} can be represented as an undirected graph, where sⁿ is a random vector, then a node v in the graph represents one component scalar random variable sᵥ. Furthermore, for any two nodes u, v∈

[symbol]

$$( u , v ) ∉ ℰ ⇒ {s}_{u} ⊥ {s}_{v} \vert {s}_{𝒱 ∖ \{ u , v \}} , \qquad ( 9 )$$

where ⊥ denotes independence and | denotes conditioning.

In this disclosure, the term “family of distributions” is used when describing an undirected graphical model. It is appreciated that there may exist many distributions that have the same factorization structure and hence the same undirected graphical representation, but with different mass/density functions. There exists a stronger graph separation property in undirected graphical models, as stated next.

A graph separation property is now defined. Consider mutually disjoint subsets A, B and C of V. Then the conditional independence relations S_{A}⊥S_{B}|S_{C} holds for all distributions in the family of distributions represented by the undirected graph whenever there is no path from a node in A to a node in B that does not pass through a node in C.

Thus far undirected graphs have been defined in terms of their conditional independencies via the graph separation property. Next alternate definition of an undirected graphical model is considered by defining functions over the maximal cliques (fully connected subgraphs) of the graph. The definition is provided by the Hammersley-Clifford theorem.

The Hammersley-Clifford theorem states that any strictly positive distribution pₛ_{ⁿ} over [symbol] can be represented by an undefined [symbol] =( [symbol] , [symbol] ) that satisfies the factorization over maximal cliques of the graph cl*( [symbol] ),

$${p}_{s}^{n} ( {s}^{n} ) = \frac{1}{Z} {\prod }_{𝒞 ∈ cl * ( 𝒢 )} {ϕ}_{𝒞} ( {s}_{𝒞}^{n} ) \qquad ( 9.1 )$$

if and only if it satisfies the conditional independencies implied by the graph separation property. The functions defined over the maximal cliques are called the clique potentials and are positive everywhere.

The term Z in (9.1) is called the partition function. For large graphs the partition function is generally hard to compute as it requires a sum (or integral if variables are continuous) over all possible combinations of the inputs. Like undirected graphs, PGMs can be constructed over directed graphs in which conditional dependencies are conveyed by the edge direction. In directed graphs, the edge potentials represent conditional probability distributions. Note that the clique potentials in undirected graphs are not necessarily distributions.

In this disclosure, when a distribution is represented by an undirected graph, the equivalent notation [symbol] is used to denote the random variable sⁿ. Denote the super-variable over a subset of nodes as [symbol] for some [symbol] ⊂ [symbol] . Equation 9.1 can be equivalently expressed as

$${p}_{{s}_{𝒱}} ( {s}_{𝒱} ) = \frac{1}{Z} {\prod }_{𝒞 ∈ cl * ( 𝒢 )} {ϕ}_{𝒞} ( {s}_{𝒞} ) . \qquad ( 10 )$$

### Factor Graphs

Turning to FIG. 2, another class of PGMs that have found use in communications and coding theory are “factor graphs.” A factor graph is a bipartite graph consisting of two types of nodes—variable nodes ( [symbol] ) and factor nodes ( [symbol] ). Variable nodes represent random variables and factor nodes represent functions over the random variables. The probability distribution represented by a factor graph [symbol] =( [symbol] , [symbol] , [symbol] ) is given by

$${p}_{{s}_{𝒱}} ( {s}_{𝒱} ) = \frac{1}{Z} {\prod }_{a ∈ ℱ} {f}_{a} ( {s}_{𝒩 ( a )} ) . \qquad ( 11 )$$

Note that any factor graph can be converted to an undirected graph and vice versa by creating | [symbol] | cliques such that ϕₐ [symbol] fₐ, with the clique size given by |ψₐ|=deg(a) and the clique itself defined by the set [symbol] (a). FIG. 2 illustrates how an undirected graph 202 can be converted to a factor graph 204 by creating a factor node (e.g., fₐ, f_{b}, f_{c}, etc.) for each maximal clique in the undirected graph 202. Nodes belonging to the same clique are connected by edges of the same line style in undirected graph 202.

Factor graphs are used in some communication systems to model a distribution over the set of valid codewords identifiable by the system. The factors typically represent constraints between the symbols of the codeword. The low density parity-check (LDPC) is an example of such a code.

### Inference Routines

Marginal distribution computation and sampling are two of the most important inference tasks on PGMs. If a model can perform one of these tasks efficiently, it can perform the other efficiently too, since the tasks of marginalization, sampling, computing the partition function Z and computing moments are all equivalent.

Approximate marginals of a distribution pₛ_{ⁿ} can be computed using the sum-product or belief propagation algorithm (BP). The BP algorithm is iterative and converges to the (estimated) marginals with complexity exponential in the treewidth of the graph, d Described next is a BP algorithm for undirected graphical models.

Let [symbol] =( [symbol] , [symbol] ) be an undirected graphical model for pₛ_{ⁿ} that factorizes as (10). Using naive summation, with [symbol] (| [symbol] |ⁿ) operations, the marginal of a node can be computed as

$${p}_{{s}_{i}} ( {s}_{i} ) = {\sum }_{{s}_{𝒱 \backslash \{ i \}}} \frac{1}{Z} {\prod }_{𝒞 ∈ cl * ( 𝒢 )} {ϕ}_{𝒞} ( {s}_{𝒞} ) .$$

BP utilizes the factorization structure of the graph to compute marginals for all nodes by passing messages along the edges of the graph. This can allow for reusing messages in the graph to compute marginals for all nodes in fewer operations than the naive method. The messages can be interpreted as local beliefs about the marginal of a node. Two node computations of BP on an undirected graph are:
The “message” from a node i to j. For every edge (i, j)∈ [symbol] compute the messages

$${m}_{i \to j} ( {s}_{j} ) ∝ {\sum }_{{s}_{𝒟 ∖ \{ j \}}} {ϕ}_{𝒟} ( {s}_{𝒟} ) {\prod }_{k ∈ 𝒩 ( i ) ∖ \{ j \}} {m}_{k \to i} ( {s}_{i} ) , \qquad ( 12 )$$

$$where$$

$$D = {⋃}_{𝒞 ∈ cl * ( 𝒢 )} 𝒞 s . t . ( i , j ) ∈ 𝒞 .$$

The “total belief computation.” For each node i∈ [symbol] compute the (approximate) unnormalized marginals/beliefs by accumulating messages from all neighboring nodes:

$${b}_{i} ( {s}_{i} ) ∝ {\prod }_{k ∈ 𝒩 ( i )} {m}_{k \to i} ( {s}_{i} ) . \qquad ( 13 )$$

BP can also be done on factor graphs and is often more easily described since the local factorization structure is clearly represented as factors. Since factor graphs consist of two types of nodes, two types of messages can be computed. Since one can convert any undirected graph to a factor graph, the message computation described below is equivalent to (12) and (13). Three node computations of BP on a factor graph are:
The “variable to factor message” from a variable node i to factor node a. For every variable-factor edge (i, a)∈ [symbol] compute the messages

$${m}_{i \to a} ( {s}_{i} ) ∝ {\prod }_{b ∈ 𝒩 ( i )} {m}_{b \to i} ( {s}_{i} ) , \qquad ( 14 )$$

The “factor to variable message” from a factor node a to variable node i. For every factor-variable edge (a, i)∈ [symbol] compute the messages

$${m}_{a \to i} ( {s}_{i} ) ∝ {\sum }_{{s}_{𝒩 ∖ \{ i \}}} {f}_{a} ( {s}_{?? ( a )} ) {\prod }_{k ∈ 𝒩 ( a ) ∖ \{ i \}} {m}_{k \to a} ( {s}_{k} ) , \qquad ( 15 )$$

The “total belief computation.” For each node i∈ [symbol] compute the (approximate) unnormalized marginals/beliefs by accumulating messages from all neighboring factor nodes:

$${b}_{i} ( {s}_{i} ) ∝ {\prod }_{a ∈ 𝒩 ( i )} {m}_{a \to i} ( {s}_{i} ) . \qquad ( 16 )$$

To begin BP, all messages proportional to a uniform distribution may be initialized. The messages can also be initialized randomly. If the algorithm is carried out iteratively, the messages are computed for each edge according to a pre-selected order. In each iteration of the algorithm all messages are newly computed from the previous iteration's messages until convergence. To ensure stability of the algorithm the messages can be normalized after each iteration.

The marginal estimates can be obtained from the beliefs as

$${\hat{p}}_{{s}_{i}} ( {s}_{i} ) = \frac{{b}_{i} ( {s}_{i} )}{{‖ {b}_{i} ‖}_{1}} . \qquad ( 17 )$$

A complete BP algorithm for factor graphs is show as Algorithm 1.

Algorithm 1: Belief propagation (BP) on a factor graph.

```
Data: Graph [symbol]  = ( [symbol]  , [symbol]  , [symbol]   ) and factor potentials fₐ for all a ∈ [symbol] .
Result: Estimated marginals probabilities \hat{p}ₛ_{ᵢ} for all nodes i ∈ [symbol] .
/* Initialize messages to the uniform distribution over | [symbol]   | */
${m}_{i \to j} ← 1 ;$
/* Started iterative BP */
T ← 0;
repeat
  T ← T + 1;
  for all variable-factor edges (i, a) ∈ [symbol]  do
    ${m}_{i \to a}^{( T )} ( {s}_{i} ) ← {\prod }_{b ∈ N ( i )} {m}_{b \to i}^{( T - 1 )} ( {s}_{i} ) ;$
  end
  for all factor-variable edges (i, a) ∈ [symbol]  do
    ${m}_{a \to i}^{( T )} ( {s}_{i} ) ← {\sum }_{{s}_{𝒩 ∖ \{ i \}}} {f}_{a} ( {s}_{𝒩 ( a )} ) {\prod }_{k ∈ 𝒩 ( a ) ∖ \{ i \}} {m}_{k \to a}^{( T - 1 )} ( {s}_{k} ) ;$
  end
until convergence
/* Accumulate messages at each node to estimate marginals. * /
for all variables i ∈ [symbol]   do
  ${b}_{i} ( {s}_{i} ) ← {\prod }_{a ∈ 𝒩 ( i )} {m}_{a \to i}^{( T )} ( {s}_{i} ) ;$
  ${\hat{p}}_{{s}_{i}} ( {s}_{i} ) ← \frac{{b}_{i} ( {s}_{i} )}{{‖ {b}_{i} ‖}_{1}} ;$
end
return \hat{p}ₛ_{ᵢ} for all nodes i ∈ [symbol] .
```

The complexity of BP is

$$𝒪 ( \vert ℰ \vert T {\vert S \vert}^{\begin{matrix}max \\ 𝒞 ∈ cl * 𝒢 \vert 𝒞 \vert\end{matrix}} )$$

for an undirected graph or equivalently

$$𝒪 ( \vert ℰ \vert T {\vert S \vert}^{\begin{matrix}max \\ a ∈ ℱ\end{matrix} deg ( a )} )$$

for a factor graph, where T is the number of iterations.

If the graph has no loops, BP converges to the true marginals of the distribution. If the graph has loops, BP is not guaranteed to converge, but theory shows that the approximate beliefs are often close to the true marginals. In the presence of loops the BP algorithm is an approximate inference procedure and it is called loopy BP.

The “treewidth” of a graph is defined as one less than the size of the maximal clique,

$$tw ( 𝒢 ) {=}^{Δ} {max}_{𝒞 ∈ cl * 𝒢} \vert 𝒞 \vert - 1. \qquad ( 18 )$$

Hence the complexity of BP for an undirected graph can be equivalently stated as [symbol] (| [symbol] |T [symbol] ).

This disclosure denotes by m_{i→j} the vectorized version of the messages from node i to node j,

$${m}_{i \to j} = {[ \begin{matrix}{m}_{i \to j} ( 0 ) & \begin{matrix}… & {m}_{i \to j} ( \vert 𝒮 \vert - 1 )\end{matrix}\end{matrix} ]}^{T} . \qquad ( 19 )$$

Dropping the length of the vector in the subscript simplifies the notation somewhat.

Sampling may be used for approximate inference. Given a relatively large number of samples from a distribution, the empirical distribution of the samples converges to the true distribution, which are used to approximate marginals. The law of large numbers (LLN) states that the expected value of random variable over a large number of trials approaches the true mean of the distribution. Hence, efficiently sampling allows moments of distributions to be computed.

In some cases, the Metropolis-Hastings algorithm can be used to sample from distributions with undirected graphical model representations. In some cases, a specialized version of this algorithm, called the Gibbs sampler, can be used to generate samples from PGMs. The Gibbs sampler works by first sampling a node i using its marginal distribution and then sampling a node j from the conditional distribution pₛ_{ⱼ}_{|s}_{ᵢ} using the previously sampled value of sᵢ. With i and j sampled, a new node k is sampled from pₛ_{ⱼ}_{|s}_{_{{i,j}}}. This process can be carried on sequentially until all nodes have been sampled. The conditional distributions can be computed efficiently using the belief propagation algorithm.

### Model-Free Coding

Embodiments of the present disclosure may utilize a code that is model-free and relatively simple to implement. In addition, the code may be selected such that it can be decoded via simple transformations and statistical inference algorithms. An example of such a code that may be used is a low density parity-check (LDPC) code.

LDPC codes are a family of linear codes developed for use in channel coding. A code is linear if it is a subspace of some vector space [symbol] , where [symbol] is a finite-field. Let the source sequence belong to a (n−k) dimensional subspace of the vector space [symbol] of dimension n, where [symbol] is a finite-field of size | [symbol] |. The linear code [symbol] ⊂ [symbol] maps the source sequence to a codeword of length n via multiplication with a generator matrix G∈ [symbol] =[Iₙ₋ₖ|P],

$${( {s}^{( n - k )} )}^{T} {G}^{T} = {( {c}^{n} )}^{T} = [ \begin{matrix}{( {s}^{( n - k )} )}^{T} & {( {s}^{( n - k )} )}^{T} P\end{matrix} ] . \qquad ( 20 )$$

The k additional codeword symbols are called the parity-check symbols and are used to verify that the source sequence is correctly decoded. The linear code can be equivalently described using a parity-check matrix H∈ [symbol] that describes the computation of the parity information, where HG^{T}=0:

$$ℒ = \{ {c}^{n} \vert {( {c}^{n} )}^{T} = {( {s}^{( n - k )} )}^{T} {G}^{T} \} = \{ {c}^{n} \vert H {c}^{n} = 0 \} . \qquad ( 21 )$$

LDPC codes are sparse linear codes with minimal column and row weights in the parity-check matrix. In this disclosure, all codes over the binary alphabet are defined and the parity-check matrix for source coding is used. H projects the source sequence sⁿ to a codeword c^{k} of length k via the projection

$${c}^{k} = H {s}^{n} . \qquad ( 22 )$$

Of note, the multiplication and addition in the matrix operations are also defined over the finite-field [symbol] . Hence, in the case of binary symbols, addition is equivalent to integer addition modulo two.

Now described is a technique for decoding LDPC codes. Assume that each symbol in the source is binary. Given an LDPC code represented by the parity-check matrix [symbol] =C(H), H∈{0,1}^{k×n}, maximum a posteriori (MAP) decoding can be used to solve (22) for the source sequence sⁿ. Given external beliefs p_{y}_{ᵢ}_{|s}_{ᵢ} about the observed value yᵢ of a symbol sᵢ, the MAP estimate of the symbol is

$$\begin{matrix}{\hat{s}}_{i}^{M A P} = arg {max}_{{s}_{i} ∈ \{ 0 , 1 \}} {p}_{{s}_{i} \vert {y}^{n}} ( {s}_{i} \vert {y}^{n} ) \\ = arg {max}_{{s}_{i} ∈ [ 0 , 1 \}} {\sum }_{{s}_{j} , j \neq i} {p}_{{s}^{n} \vert {y}^{n}} ( {s}^{n} \vert {y}^{n} ) \\ = arg {max}_{{s}_{i} ∈ [ 0 , 1 \}} {\sum }_{{s}_{j} , j \neq i} {p}_{{y}^{n} \vert {s}^{n}} ( {y}^{n} \vert {s}^{n} ) {p}_{{s}^{n}} ( {s}^{n} ) \\ = arg {max}_{{s}_{i} ∈ [ 0 , 1 \}} {\sum }_{{s}_{j} , j \neq i} {\prod }_{i = 1}^{n} {p}_{{y}_{i} \vert {s}_{i}} ( {y}_{i} \vert {s}_{i} ) {1}_{{c}^{k} = H {s}^{n}} ( 24 )\end{matrix} . \qquad ( 23 )$$

Regarding the MAP decoder, the maximum value of the marginal distribution of symbol i in (23) is desired. Conditional distribution can be rewritten as marginalization over the joint distribution that factorizes according to (24).

This approach resembles the factorization structure inherent to factor graphs. Thus, p_{y}_{ⁿ}_{,s}_{ⁿ}(yⁿ, sⁿ) can be modeled as factor graph [symbol] =( [symbol] , [symbol] , [symbol] ) with one factor for each external belief and one factor for each row constraint of the LDPC parity-check matrix:

$$ℱ = \{ {f}_{i} ( {s}_{i} ) for all i ∈ 𝒱 \} ⋃ \{ {g}_{j} ( {s}^{n} ) for j = 1 , 2 , … , k \} , \qquad ( 25 )$$

$$where$$

$${f}_{i} ( {s}_{i} ) {=}^{△} {p}_{{y}_{i} \vert {s}_{i}} ( {y}_{i} \vert {s}_{i} ) , \qquad ( 26 )$$

$${g}_{j} ( {s}^{n} ) {=}^{△} {1}_{\{ {c}_{j} = {H}^{j} {s}^{n} \}} . \qquad ( 27 )$$

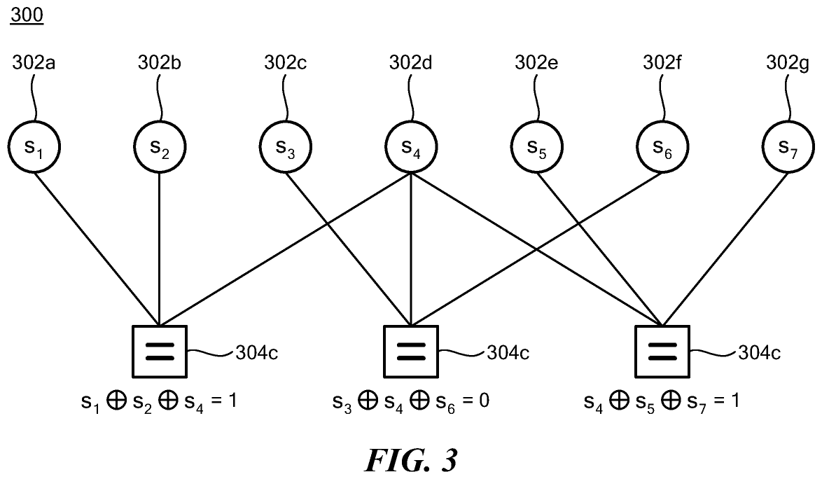

Turning to FIG. 3, the factor graph representation of an LDPC parity-check matrix is referred to as a “Tanner graph.” With the Tanner graph representation, the marginals for all nodes can be computed by running BP over the factor graph.

As an example, consider the following parity-check matrix

$$H = ( \begin{matrix}1 & 1 & 0 & 1 & 0 & 0 & 0 \\ 0 & 0 & 1 & 1 & 0 & 1 & 0 \\ 0 & 0 & 0 & 1 & 1 & 0 & 1\end{matrix} ) .$$

Assume that the input source sequence is s⁷=(1,1,1,1,0,0,0). The factors representing the parity-check matrix constraints are

$${g}_{1} ( {s}_{1} , {s}_{2} , {s}_{4} ) = {1}_{\{ {s}_{1} ⊕ {s}_{2} ⊕ {s}_{4} = 1 \}}$$

$${g}_{2} ( {s}_{3} , {s}_{4} , {s}_{6} ) = {1}_{\{ {s}_{3} ⊕ {s}_{4} ⊕ {s}_{6} = 0 \}}$$

$${g}_{3} ( {s}_{4} , {s}_{5} , {s}_{7} ) = {1}_{\{ {s}_{4} ⊕ {s}_{5} ⊕ {s}_{7} = 1 \}} .$$

FIG. 3 shows a Tanner graph 300 representing H, for this example. In graph 300, circular elements 302a-g represent inputs, rectangular elements 304a-c represent parity-check matrix constraints, and lines indicate which inputs are involved with particular constraints.

### Sum-Product Networks

PGMs can answer probabilistic queries through marginalization via BP and sampling. However, the computational cost of exact inference is often expensive for models representing complex distributions. This section introduces a class of probabilistic generative models called sum-product networks (SPNs). Next provided is an explanation of how SPNs solve the high complexity issue faced with PGMs and how, by architectural modifications, an SPN can be viewed as deep PGM.

As used herein, the term “tractable model” refers to a probabilistic model in which exact inference requires a polynomial number of operations. Hence, inference can be performed with a tractable cost in both memory and time.

An example of a tractable model is a tree structured PGM where each marginal can be exactly computed using the BP algorithm with [symbol] (nT| [symbol] |²) complexity. When the graph has loops (i.e., is “loopy”), BP inference is no longer exact, and the junction tree algorithm can instead be used to perform exact inference. The junction tree algorithm transforms a loopy graph into a tree structured graph with alphabet size per node upper bounded by [symbol] resulting in a total inference cost of [symbol] (nT [symbol] ). The cost of exact inference can grow exponentially large for graphs with complex structures (i.e., large treewidths). Since exact inference is expensive on loopy graphs, approximate inference techniques such as loopy BP, variational approximations and MCMC can be used to estimate probabilistic queries.

Consider the MNIST dataset of handwritten digits, a commonly used benchmark for classification tasks. To obtain probabilistic queries on an image from this dataset using the techniques discussed above, it is necessary to learn a PGM to represent the images. Structure learning in PGMs with discrete variables is not straightforward and moreover structure learning uses inference as a subroutine.

It is appreciated herein that SPNs help overcome many of these issues. They are probabilistic models that admit exact and tractable inference with complexity linear in the size of the model.

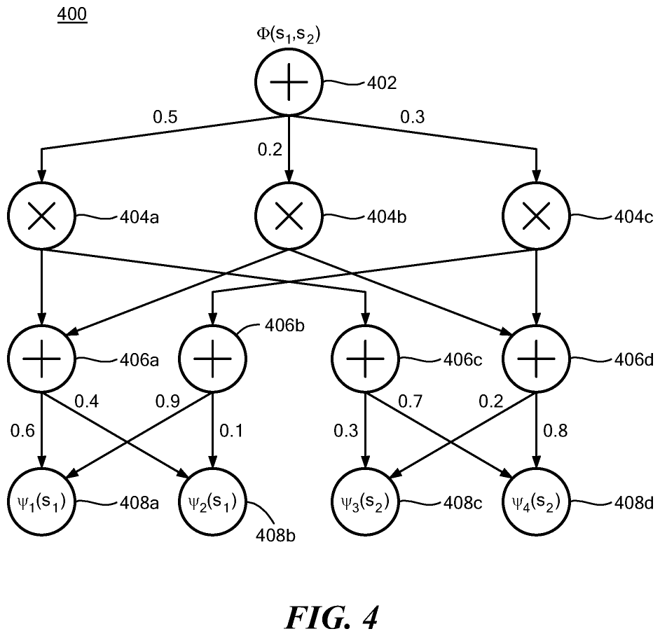

Turning to FIG. 4, an SPN is a deep probabilistic that represents a joint probability distribution over a set of random variables represented by a random vector, herein denoted sⁿ.

Formally, an SPN Φ is a rooted directed acyclic graph (DAG) whose leaves are tractable probability distributions and whose internal nodes are sums and products. Each outgoing edge (i, j) from a sum node is associated with a non-negative weight w_{i,j}. The value of an SPN Φ(sⁿ) is the value of its root. The “scope” of a node u is the set of variables that are descendants of u. The scope of a leaf node is the set of variables represented by the node.

The following procedure may be used to evaluate an SPN. Let Φ be an SPN and let sⁿ be a source sequence with a desired likelihood. The evaluation of the SPN can proceed from the leaves to the root with the following rules:
1. If u is a leaf node of the DAG, it is associated with a probability distribution ψᵤ. The output of the node is

$${ψ}_{u} ( {s}_{s c ( u )}^{n} ) .$$

Examples of leaf distributions are indicator distributions, categorical distributions and Gaussian distributions. If the leaf distribution is Gaussian and the scope of u is sc(u)={1,3,4}, then

$${ψ}_{u} ( {s}_{s c ( u )}^{n} ) = N ( {s}_{s c ( u )}^{n} ; {μ}_{u} , {\sum }_{u} )$$

where μᵤ is a 3-dimensional vector.
2. If u is a product node, the output is the product of its children's values.

$${Φ}_{u} ( {s}^{n} ) = {\prod }_{v ∈ ch ( u )} {Φ}_{v} ( {s}^{n} ) . \qquad ( 28 )$$

3. If u is a sum node, the output is the weighted sum of its children's values,

$${Φ}_{u} ( {s}^{n} ) = {\sum }_{v ∈ c h ( u )} {w}_{u , v} {Φ}_{v} ( {s}^{n} ) . \qquad ( 29 )$$

Given partial observations of the input sequence

$${s}_{𝒜}^{n} ,$$

[symbol]

⊂{1, . . . , n} the marginal probabilities of the input can still be computed. In this case, the evaluation procedure can be modified to marginalize out unobserved values in the leaf distribution, i.e.,

$${s}_{sc ( u ) ∖ 𝒜}^{n} .$$

Hence, the new leaf node evaluation step is

$${ψ}_{u} ( {s}_{sc ( u ) ⋂ 𝒜}^{n} ) = {\sum }_{{s}_{sc ( u ) ∖ 𝒜}^{n}} {ψ}_{u} ( {s}_{sc ( u ) ∖ 𝒜}^{n} , {s}_{sc ( u ) ⋂ 𝒜}^{n} ) . \qquad ( 30 )$$

Some definitions related to SPNs are now provided. An SPN Φ that models some distribution pₛ_{ⁿ} is “valid” if and only if

$$Φ ( {s}_{𝒜}^{n} ) = Z {p}_{{s}_{𝒜}^{n}} ( {s}_{𝒜}^{n} )$$

for all [symbol] ⊂{1, . . . , n}. In other words, the SPN is valid if it always correctly computes marginal probabilities (e.g., unnormalized marginal probabilities). An SPN is “complete” if all children of a sum node have identical scopes. An SPN is “decomposable” if all children of the same product node have pairwise disjoint scopes. Thus, as appreciated herein, if an SPN is complete and decomposable, then it is valid. A “normalized” SPN is an SPN wherein the weights at every sum node add up to one; such an SPN always outputs normalized probabilities.

Embodiments of the present disclosure, discussed in detail below, provide for an SPN architecture that is both complete and decomposable and, in some cases, always outputs normalized probabilities.

FIG. 4 shows an example of a normalized SPN over two random variables, s₁, s₂. Illustrative SPN 400 includes a root node 402, a plurality of product nodes 404a-c (404 generally) connected thereto, a plurality of sum nodes 406a-d (406 generally) each connected to one of more of the product nodes 404a-c, and a plurality of leaf nodes 408a-d (408 generally) each connected to a pair of the sum nodes 406a-d. The number of nodes, types of nodes, and arrangement of nodes shown in FIG. 4 is merely illustrative. Other number, types, and/or arrangements of SPN nodes can differ according to the general concepts, techniques, and structures sought to be protected herein.

Leaf nodes 408 have singular scope and can contain any tractable distribution. If the leaf distribution is an indicator, the weights along the edges from the leaf 408 to sum node 406 are parameters for a categorical distribution. If the leaf distributions are, for example, Gaussian then the SPN can be interpreted as mixture model.

Consider the illustrative SPN 400 in FIG. 4 defined over binary random variables, s₁, s₂. The leaf distributions (e.g., distributions associated with leaf nodes 408) can be modeled as indicators,

$${ψ}_{1} ( {s}_{1} ) = {1}_{\{ {s}_{1} = 1 \}} {=}^{Δ} {s}_{1}$$

$${ψ}_{2} ( {s}_{1} ) = {1}_{\{ {s}_{1} = 0 \}} {=}^{Δ} {\overline{s}}_{1}$$

$${ψ}_{3} ( {s}_{2} ) = {1}_{\{ {s}_{2} = 1 \}} {=}^{Δ} {s}_{2}$$

$${ψ}_{4} ( {s}_{2} ) = {1}_{\{ {s}_{2} = 0 \}} {=}^{Δ} {\overline{s}}_{2}$$

It can be seen that SPN 400 is complete and decomposable and, hence, valid. The distribution represented by SPN 400 can be written in network polynomial form as

$$Φ ( {s}_{1} , {s}_{2} ) = 0.5 ( 0.6 {s}_{1} + 0.4 {\overline{s}}_{1} ) ( 0.3 {s}_{2} + 0.7 {\overline{s}}_{2} ) + 0.2 ( 0.6 {s}_{1} + 0.4 {\overline{s}}_{1} ) ( 0.2 {s}_{2} + 0.8 {\overline{s}}_{2} ) + 0.3 ( 0.9 {s}_{1} + 0.1 {\overline{s}}_{1} ) ( 0.2 {s}_{2} + 0.8 {\overline{s}}_{2} ) .$$

The following examples show now SPN 400 can be used to compute marginal probabilities of some queries.

$$1. If {s}_{1} = 1 and {s}_{2} = 0 ,$$

$$\begin{matrix}{p}_{{s}_{1} , {s}_{2}} ( 1 , 0 ) = Φ ( 1 , 0 ) \\ = 0.5 \times 0.6 \times 0.7 + 0.2 \times 0.6 \times 0.8 + 0.3 \times 0.9 \times 0.8 \\ = 0.522 .\end{matrix}$$

$$2. If {s}_{1} = 1 and {s}_{2} = 1 ,$$

$$\begin{matrix}{p}_{{s}_{1} , {s}_{2}} ( 1 , 1 ) = Φ ( 1 , 0 ) \\ = 0.5 \times 0.6 \times 0.3 + 0.2 \times 0.6 \times 0.2 + 0.3 \times 0.9 \times 0.2 \\ = 0.16 7 \overline{9} .\end{matrix}$$

3. If s₁=1, s₂ must first be marginalized out from every leaf distribution according to (30). Only the leaf distributions involving s₂ are modified:

$${ψ}_{3} = 0 + 1 = 1 ,$$

$${ψ}_{4} = 0 + 1 = 1 .$$

The network polynomial with these marginalized leaf distributions is

$${p}_{{s}_{1}} ( 1 ) = Φ ( {s}_{1} ) = 0.5 \cdot 0.6 ( 0.3 + 0.7 ) + 0.2 \cdot 0.6 ( 0.2 + 0.8 ) + 0.3 \cdot 0.9 ( 0.2 + 0.8 ) = {p}_{{s}_{1} , {s}_{2}} ( 1 , 1 ) + {p}_{{s}_{1} , {s}_{2}} ( 1 , 0 ) . \qquad ( 31 )$$

Of note, in order to marginalize out s₂, the leaf “distribution” can be set to a constant function that always evaluates to 1.

The result in (32) is useful in computing marginals. This result can be stated as follows: if all leaves in an SPN involving sᵢ have singular scope, one can marginalize out sᵢ by setting the leaf distribution functions involving this random variable to always evaluate to unity.

An SPN encodes all possible inference queries whereas a PGM gives the unnormalized probability of a full source sequence. As illustrated by the example of FIG. 4, all marginals in an SPN can be computed in a single forward pass from leaves to nodes with complexity linear in the number of edges in the underlying DAG. An undirected graph can be converted to an SPN by grouping together recurring computation by merging the computation subgraphs within the SPN DAG. The sum and product operations represented as a DAG can be implemented very efficiently using parallel processors/GPUs. This allows SPNs to perform fast inference on high-treewidth graphs which would otherwise require approximate inference with PGMs.

In contrast with PGMs, SPNs can circumvent the need for approximate inference algorithms to compute the partition function since it can be evaluated by marginalizing out all variables, i.e., setting all leaf distribution functions to one. Moreover, it has been shown that SPNs can represent non-factorizable high treewidth models more compactly. SPNs can compactly represent contextual-independencies with fast inference times by coalescing nodes and edges together. Whereas PGMs learned from data are often intractable unless the model size is kept small. SPNs can learn from large amounts of data with fast learning algorithms. SPNs can be made very deep and can be implemented very efficiently using tensorized operations. Moreover, parameter learning is very efficient and hence the same SPN architecture can be used to model different sources of data.

SPNs also offer advantages over arithmetic circuits and deep generative models. SPNs are more general than arithmetic circuits because the leaf distribution need not be an indicator but rather any tractable distribution. Moreover. SPNs can be made quite deep and have weights along sum nodes to model complex distributions. Deep generative models typically only output the likelihood of complete data whereas SPNs can answer marginal queries of incomplete data.

### Deep Generalized Convolutional Sum-Product Networks

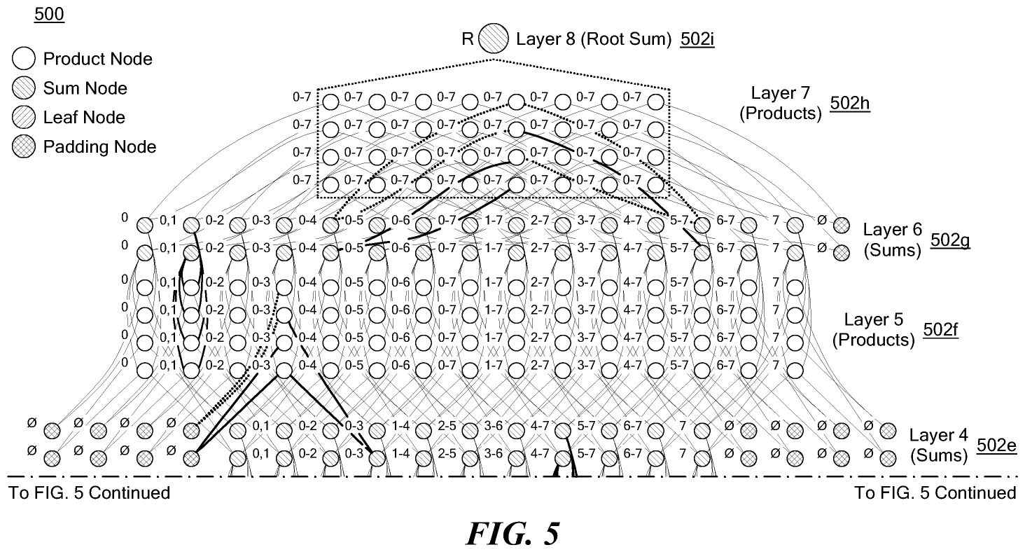

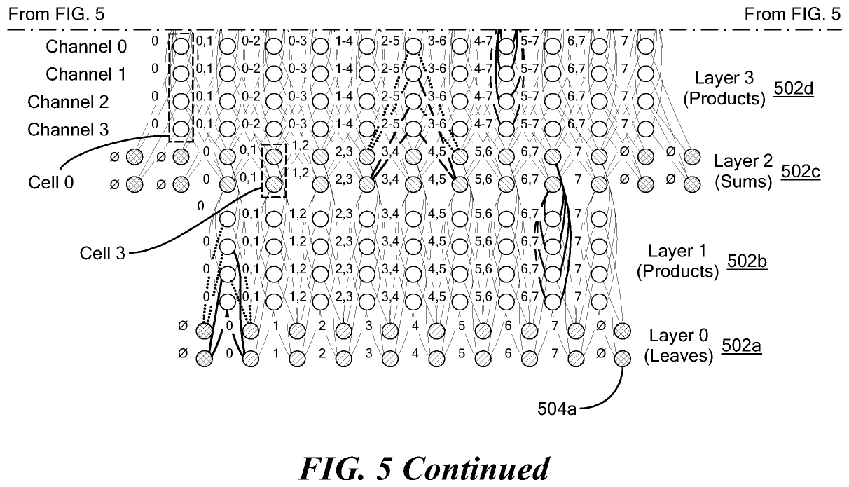

Turning to FIG. 5, as previously discussed, SPNs can be implemented on GPUs using convolutions efficiently. According to embodiments of the present disclosure, so-called deep generalized convolutional SPN (DGCSPN) can be used for data compression (e.g., lossless compression of images).

FIG. 5 shows an example of a DGCSPN 500 having eight layers 502a-i with layer zero 502a corresponding to the leaf nodes and layer eight 502i corresponding to the root node. Each leaf node in layer zero 502a corresponds to a single symbol in the input source, i.e., layer zero 502a comprises the leaf distributions. Layers 502b-i may alternate between product nodes and sum nodes, as shown. In addition to product and sum nodes, DGCSPN 500 can include padding nodes (e.g., node 504), which are set to 0 in the log domain, are used to ensure that GPU-optimized convolutions can be used correctly. The numbers within individual nodes indicate “scope” and all children of the same sum node have the same scope.

The number of layers, number of nodes, and placement of edges shown in FIG. 5 are merely illustrative and the general concepts, techniques, and structures sought to be protected herein are not limited to any particular DGCSPN architecture.

With a DGCSPN architecture:
Leaf nodes have singular scope, i.e., they correspond to a single symbol in the input source
Sum layers and product layers are stacked in an alternating fashion.
Log-probabilities can be propagated to avoid underflow issues.
A sum node is implemented in the log-domain using the log-sum exponential “trick.”

$${\tilde{Φ}}_{u} ( {s}^{n} ) = log ( {\sum }_{ν ∈ c h ( u )} exp ( {\tilde{w}}_{u , v} + {\tilde{Φ}}_{v} ( {s}^{n} ) - c ) ) + log c , \qquad ( 32 )$$

where ã=log a and c is some positive constant.
S output channels are created at every sum node by adding P input channels, each having the same scope, from the previous product layer. For example, in FIG. 5, P=4 channels in layer one 502b are summed up twice to produce S=2 output channels in layer two 502c.
Product layers are implemented as convolutions with increasing dilation rates at every subsequent layer. The convolutional patches overlap in every layer since the stride chosen is one. To ensure that the decomposability property is satisfied by the SPN, subsequent product layers must use a dilation factor that is twice that of the previous product to layer. A dilation factor of k in a convolution adds k−1 zeros between each element of the kernel. This is shown in FIG. 5 by the increasing distance between inputs to product nodes as the layer increases.
Like the sum nodes, P output channels are created at every product node by multiplying S instances/channels of a sum node with disjoint scopes from the previous sum layer. Padding nodes (e.g., node 504a), which are set to 0 in the log domain, are used to ensure that GPU-optimized convolutions can be used correctly as previously mentioned.

According to some embodiments, a DGCSPN architecture can utilize “indicator leaves” (e.g., instead of Gaussian leaves) to allow for computing marginal probabilities easily for use with BP on Tanner graphs. In some embodiments, a DGCSPN architecture may provide support for 1-dimensional convolutions (e.g., for learning non-image sources). In some embodiments, a DGCSPN architecture may provide a routine for computing the mean percentage error (MPE) of a partially observed source for non-Gaussian leaf distributions. In some embodiments, a DGCSPN architecture may provide a routine to compute unary marginals in parallel. In some cases, a DGCSPN architecture implementation—such as the Py Torch implementation DeeProb-kit—may be modified to provide one more or said features.

### Parameter Learning

Parameter learning in SPNs can done via gradient descent or the expectation-maximization (EM) algorithm. In the case where DGCSPNs are implemented using PyTorch, a deep learning framework, gradient descent may be used for learning the model parameters. In some cases, only indicator leaves may be used and, thus, the only weights that need to be learned are the weights along edges emanating from a sum node.

For numerical stability, log-probabilities can be propagated in the SPN. The optimization problem of the learning procedure is the minimization of the negative log-likelihood of the data,

$$arg {min}_{{s}^{n}} - log Φ ( {s}^{n} ) . \qquad ( 33 )$$

To perform gradient descent, it may be necessary to obtain the derivative of the log-probability with respect to the edge weight w_{i,j} from a sum node i to a product node j:

$$\frac{\partial }{\partial {w}_{i , j}} log Φ ( {s}^{n} ) = \frac{1}{Φ ( {s}^{n} )} \frac{\partial Φ ( {s}^{n} )}{\partial {w}_{i , j}} \qquad ( 34 )$$

$$= \frac{1}{Φ ( {s}^{n} )} \frac{\partial Φ ( {s}^{n} )}{\partial {Φ}_{i} ( {s}^{n} )} \frac{\partial {Φ}_{t} ( {s}^{n} )}{\partial {w}_{i , j}} \qquad ( 35 )$$

$$= \frac{1}{Φ ( {s}^{n} )} \frac{\partial Φ ( {s}^{n} )}{\partial {Φ}_{i} ( {s}^{n} )} {Φ}_{j} ( {s}^{n} ) . \qquad ( 36 )$$

Thus, the parameters can now be updated as

$${w}_{i , j} ← {w}_{i , j} - η \frac{\partial }{\partial {w}_{i , j}} , \qquad ( 37 )$$

where η is the learning rate.

In some embodiments, gradient computation can be implemented in PyTorch using the optimized autograd function. In some cases, these gradients can be used to compute the marginals of all the leaf node variables in a single forward and backward pass of the network.

### Parallel Marginal Computation

Now described is a procedure to compute the marginals of all the variables in a single forward and backward pass of an SPN with singular scope indicator leaves. It has been shown that in an arithmetic circuit, the posterior marginal of a leaf variable can be computed using gradients. Though arithmetic circuits use indicator leaves, the same formula can give the leaf distribution assignment probability in a general SPN. The formula is,

$${p}_{{[ {s}_{i} ]}_{k} \vert {s}_{𝒜}^{n}} ( {[ {s}_{i} ]}_{k} \vert {s}_{𝒜}^{n} ) = \frac{1}{Φ ( {s}_{𝒜}^{n} )} \frac{\partial Φ ( {s}_{𝒜}^{𝔫} )}{\partial {ψ}_{k}} , \qquad ( 38 )$$

where [sᵢ]ₖ represents the k′th leaf distribution instance that involves sᵢ.

For example, in FIG. 4, there are two leaf distributions for sᵢ—ψ₁ and ψ₂. Thus,

$${p}_{{[ {s}_{1} ]}_{2} \vert {s}_{𝒜}^{n}} ( {[ {s}_{1} ]}_{2} \vert {s}_{𝒜}^{n} )$$

is the assignment probability of leaf distribution ψ₂ given the observed data

$${s}_{𝒜}^{n} .$$

For example, if the leaves are Gaussian, the probabilities can be interpreted as being similar to the soft mixture assignment probabilities, p_{z}, in Gaussian Mixture Models (GMMs):

$${p}_{x} ( x ) = {\sum }_{i} {p}_{x \vert z} ( x \vert z ) {p}_{z} ( z ) \qquad ( 39 )$$

where z∈ [symbol] represents the number of clusters in the GMM. When the leaf distributions are indicators then (38) is equivalent to the categorical marginal probability of the discrete random variable sᵢ:

$${p}_{{[ {s}_{i} ]}_{k} \vert {s}_{𝒜}^{n}} ( {[ {s}_{i} ]}_{k} \vert {s}_{𝒜}^{n} ) = {p}_{{s}_{i} \vert {s}_{𝒜}^{n}} ( k \vert {s}_{𝒜}^{n} ) . \qquad ( 40 )$$

As previously discussed, embodiments of the present disclosure can propagate log-probabilities in an SPN. To allow for this, it may be necessary to relate the gradients in the log-domain to (38).

$$\begin{matrix}\frac{\partial log Φ ( {s}_{𝒜}^{n} )}{\partial log {ψ}_{k}} = \frac{\partial log Φ ( {s}_{𝒜}^{n} )}{\partial Φ ( {s}_{𝒜}^{n} )} \frac{\partial Φ ( {s}_{𝒜}^{n} )}{\partial log {ψ}_{k}} & ( 41 ) \\ = \frac{1}{Φ ( {s}_{𝒜}^{n} )} \frac{\partial Φ ( {s}_{𝒜}^{n} )}{\partial log {ψ}_{k}} \frac{{ψ}_{k}}{{ψ}_{k}} & \\ = \frac{1}{Φ ( {s}_{𝒜}^{n} )} \frac{\partial Φ ( {s}_{𝒜}^{n} )}{\partial log {ψ}_{k}} \frac{\partial log {ψ}_{k}}{\partial {ψ}_{k}} {ψ}_{k} & \\ = \frac{1}{Φ ( {s}_{𝒜}^{n} )} \frac{\partial Φ ( {s}_{𝒜}^{n} )}{\partial {ψ}_{k}} {ψ}_{k} & \\ = {p}_{{[ {s}_{t} ]}_{k} \vert {s}_{𝒜}^{n}} ( {[ {s}_{i} ]}_{k} \vert {s}_{𝒜}^{n} ) since {ψ}_{k} = 1 . & ( 42 )\end{matrix}$$

Of note, (41) uses the fact sᵢ is unobserved and hence was marginalized out in the forward pass of the SPN. As discussed above in the context of FIG. 4, all leaf distributions containing sᵢ in their scope must be set to unity (1) in order to marginalize out sᵢ.

Thus, with a single forward pass and backward pass through the SPN, all desired marginals can be computed for the provided evidence.

### Inference with External Beliefs

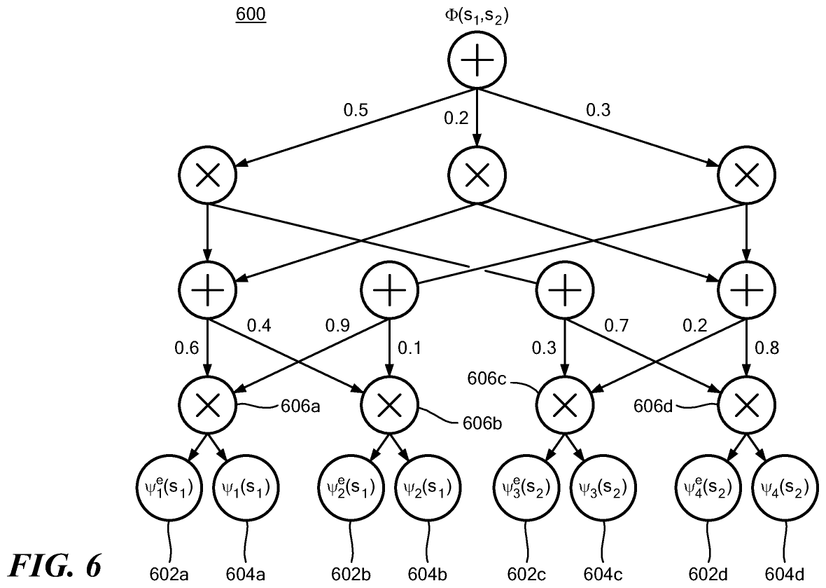

Turning to FIG. 6, according to some embodiments, data compression may be provided using an SPN along with a BP algorithm. To allow for this, an architecture may be selected that is capable of using externals beliefs about the input source to answer probabilistic queries. In a PGM, external beliefs bᵢ at a node sᵢ are incorporated by scaling the node potential ϕᵢ by the value of the external belief,

$${ϕ}_{i}^{′} ( {s}_{i} ) = {b}_{i} ( {s}_{i} ) {ϕ}_{i} ( {s}_{i} ) . \qquad ( 43 )$$

These external beliefs may come from some external graph that encodes other statistical properties about the source. The external belief is treated as an independent factor in the joint distribution.

SPNs can consume external beliefs in a similar manner by multiplying the external belief distribution with the leaf distributions. FIG. 6 illustrates this augmentation by modifying the SPN from FIG. 4. In more detail, SPN 600 of FIG. 6 includes leave nodes 602a-d corresponding to external beliefs in addition to leaf nodes 604a-d corresponding to the leaf distribution. The external beliefs are multiplied with the leaf distribution via product nodes 606a-d, as shown.

Assume that the SPN has indicator leaves. Let the external belief to the k′th leaf distribution that has sᵢ in its scope be

$${ψ}_{k}^{e} .$$

The posterior marginal formula can be modified to remove the effect of scaling the leaf distribution when doing a forward pass through the model. Hence, (40) can become,

$${p}_{{s}_{i} \vert {s}_{𝒜}^{n}} ( k \vert {s}_{𝒜}^{n} ) = \frac{1}{{ψ}_{k}^{e} Φ ( {s}_{𝒜}^{n} )} \frac{\partial Φ ( {s}_{𝒜}^{n} )}{\partial {ψ}_{k}} . \qquad ( 44 )$$

The general concepts and techniques discussed above can be applied to use SPNs for developing data compression architectures (e.g., lossless compression architectures) with model-code separation baked into the design, according to embodiments of the present disclosure.

### Model-Code Separation Architecture

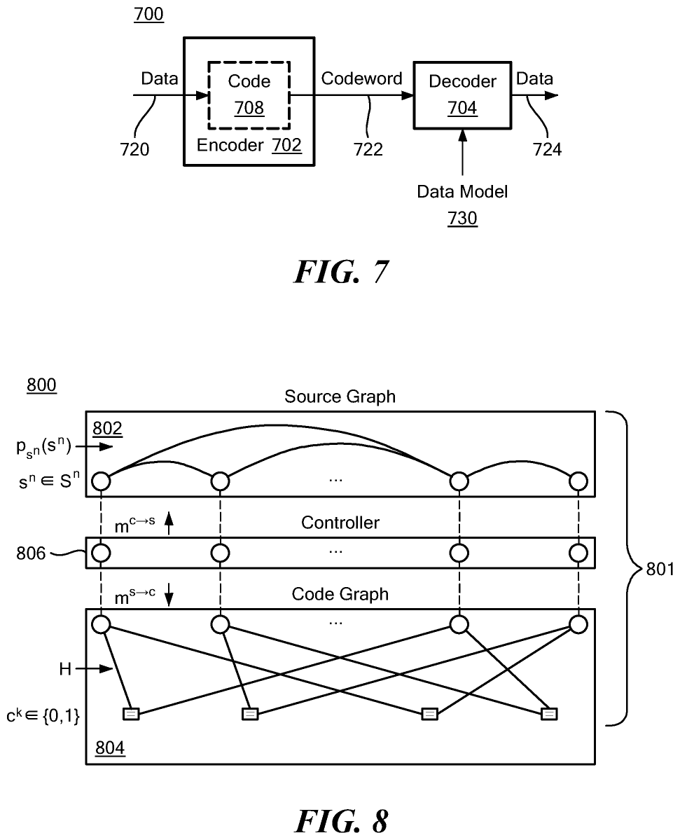

FIG. 7 shows an example of a data compression system having a model-code separation architecture. An illustrative compression system 700 can have an encoder 702 and a decoder 704. Encoder 702 receives source data 720 and generates a compressed 722 version of the data as output. The compressed data 712 may be stored to non-volatile computer memory, transmitted over a computer network, etc. Decoder 704 receives compressed data 722 as input and generates reproduced data 724 using a model 730 of the source data. In the case of lossless compression, reproduced data 724 will be identical to the source data 720.

The architecture of FIG. 7 uses a compression pipeline with a model-free encoder and model-adaptive decoder. Note that the decoder is provided with some information about the coding mechanism to decode the source data.

The functionality described herein in conjunction with encoder 702 and/or decoder 704 may be implemented using computing software, firmware, hardware, or some combination thereof. In some embodiments, encoder 702 and/or decoder 704 may correspond to computer-executable instructions in the form of a computer application, library, module, component, etc. In some embodiments, encoder 702 and/or decoder 704 may comprise computer hardware (e.g., processors, memory, etc.) configured to execute said computer-executable instructions.

To aid in understanding, first described is a PGM-based model-code separation architecture. Then it is shown how the PGM can be replaced with an SPN, according to embodiments of the present disclosure.

### PGM-Based Model-Code Separation Architecture

Here described is a model-code separation architecture that uses a PGM as the data model. The architecture follows the design of FIG. 7 with the encoder given no prior knowledge about the source. In this architecture, the decoder can be made as powerful as needed. In particular, it can be assumed that the decoder is aware of the source structure in the form of a source graph, a PGM representing the statistical structure in the input signal. This suggests that the ideal code would be one that lends itself to optimal decoding using belief propagation. A suitable choice is the family of LDPC codes which can be represented as factor graphs.

Discussed first is the compression of binary sequences of length n, sⁿ∈ [symbol] where [symbol] ={0,1}.

The encoder compresses the source via a simple projection with an LDPC parity-check matrix. Given a source sequence of length n and a target compression rate of r_{code}=k/n, the encoder generates a random LDPC parity-check matrix H∈{0,1}^{k×n}. As used herein, the term “coding transform” generally refers to any set of values that is applied to a source sequence to generate compressed/coded data. A parity-check matrix H is one example of coding transform. For non-LDPC codes, coding transforms may take a non-matrix form. The compressed sequence is obtained as

$${c}^{k} = {Hs}^{n} . \qquad ( 45 )$$

Since H is a tall matrix, the compressed sequence c^{k} corresponds to many possible source sequences. If sⁿ is decoded using BP on the Tanner graph of H, the decoded output might not satisfy the statistical structure inherent to the source. The source graph captures this structure and BP can be run over this graph by providing the beliefs from the Tanner graph as external node potentials. This process can be carried out iteratively until the source is decoded correctly.

The matrix H enforces k constraints which can be represented by a factor graph as demonstrated above. The resulting factor graph [symbol] =( [symbol] , [symbol] , [symbol] ) has k factor nodes, [symbol] ={1, . . . , k} and n variable nodes, [symbol] ={1, . . . , n}. The constraint represented by factor node a corresponds to row a of the LDPC matrix:

$${c}_{a} = {\sum }_{i = 1}^{n} {H}_{a , i} {s}_{i} . \qquad ( 46 )$$

The factor graph represents a uniform distribution over all codewords that satisfy the parity-check equations,

$${p}_{{s}_{𝒱}}^{c} ( {s}_{𝒱} ) = \frac{1}{{Z}_{c}} {\prod }_{a ∈ ℱ} {f}_{a} ( {s}_{𝒩 ( a )} ) = \frac{1}{{Z}_{c}} {\prod }_{a ∈ ℱ} {1}_{\{ {c}_{a} = {\sum }_{i = 1}^{n} {H}_{a , i} {s}_{i} \}} . \qquad ( 47 )$$

This factor graph is referred to as the “code graph.”

Suppose the data model is available in the form of an undirected PGM with n nodes, one for each symbol in the source sequence,

$${p}_{{s}_{𝒱}}^{s} ( {s}_{𝒱} ) = \frac{1}{{Z}_{s}} {\prod }_{𝒞 ∈ cl ( 𝒢 )} {ϕ}_{𝒞} ( {s}_{𝒞} ) . \qquad ( 48 )$$

This graph is called the “source graph.” BP can be run on the source graph by taking in external beliefs from the code graph, as discussed next.

Turning to FIG. 8, a combined source-code decoder 800 can make use of a single graph 801 formed by combining a source graph 802 and a code graph 804. The source graph 802 and code graph 804 share common nodes denoting the source symbols, as represented by virtual controller 806. Decoder 800 may correspond to decoder 704 of FIG. 7, for example.

The combined graph 801 represents the distribution,

$${p}_{{s}_{𝒱}}^{comb} ( {s}_{𝒱} ) = {p}_{{s}_{𝒱}}^{s} ( {s}_{𝒱} ) {p}_{{s}_{𝒱}}^{c} ( {s}_{𝒱} ) . \qquad ( 49 )$$

The decoder runs BP on the combined graph 801 to compute approximate marginals of the source sequence that satisfies both the source constraints and the code constraints. Only the nodes representing the source symbols interact with the graphs 802, 804 on either side of the virtual controller 806. Assume that the source graph 802 only has unary node potentials and pairwise potentials along edges. BP can be carried out efficiently using the following rules:
Begin by initializing all messages in both graphs 802, 804 to 1/| [symbol] |. Controller 806 accumulates the messages from the shared variables nodes of one graph and sends it to the other. Let the message at node u being sent from the code graph 804 to source graph 802 be

$${m}_{u \to u}^{c \to s}$$

and let the message in the other direction be

$${m}_{u \to u}^{s \to c} .$$

If u is a node in the code graph 804, accumulate the messages from the controller 806,

$${m}_{u \to u}^{s \to c} ,$$

by treating them as additional factor nodes,

$${ℊ}_{u} ( {s}_{u} ) {=}^{Δ} {m}_{u \to u}^{s \to c} ( {s}_{u} ) . \qquad ( 50 )$$

Using the updated node potentials, run BP on the code graph and compute the marginal of sᵤ by accumulating messages from all neighbors of u except the controller node. Send this message to the controller and call it

$${m}_{u \to u}^{c \to s} .$$

If u is a node in the source graph, accumulate the messages from the controller,

$${m}_{u \to u}^{c \to s} ,$$

by multiplying them with the node potentials of the source graph,

$${ϕ}_{u}^{′} ( {s}_{u} ) = {ϕ}_{u} ( {s}_{u} ) {m}_{u \to u}^{c \to s} ( {s}_{u} ) . \qquad ( 51 )$$

Using the updated node potentials, run BP on the source graph and compute the marginal of sᵤ by accumulating messages from all neighbors of u except the controller node. Send this message to the controller and call it

$${m}_{u \to u}^{s \to c} .$$

Compute the unnormalized beliefs at every node by taking the product of the beliefs from both graphs.

$${b}_{u} ( {s}_{u} ) = {m}_{u \to u}^{c \to s} ( {s}_{u} ) {m}_{u \to u}^{s \to c} ( {s}_{u} ) . \qquad ( 52 )$$

Repeat the above steps until the unnormalized beliefs converge. The decompressed output can be recovered as

$${\hat{s}}_{u} = arg {max}_{s ∈ 𝒮} {b}_{u} ( s ) . \qquad ( 53 )$$

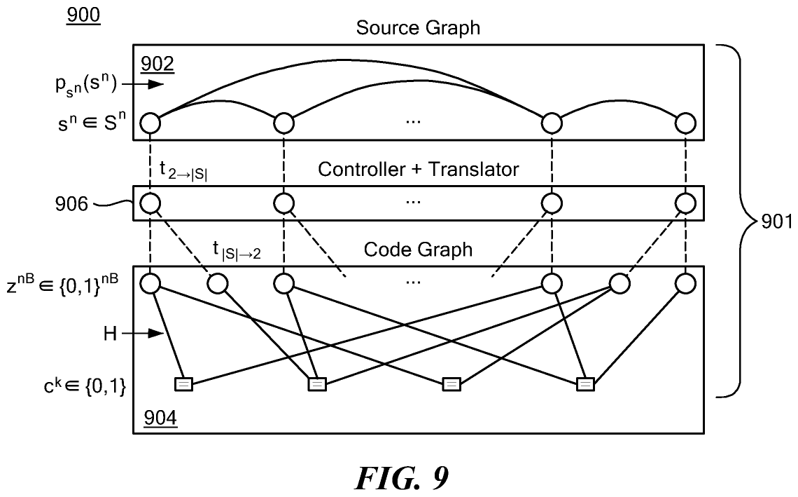

FIG. 9 shows another example of a combined source-code decoder 900 that can make use of a single graph 901 formed by combining a source graph 902 and a code graph 904. To handle non-binary sources (or “large alphabet sources”), a translator module can be introduced in the architecture. In particular, the virtual controller 806 of FIG. 8 may be configured to perform translation, as shown. Decoder 900 may correspond to decoder 704 of FIG. 7, for example.

Consider a source sequence sⁿ of length n where each symbol is drawn from an alphabet [symbol] of size | [symbol] |=M. The translator of 906 can be configured to translate the symbols into a representation that can be used by the architecture. Specifically, the code graph of the architecture that uses LDPC codes is constrained to use a bit-level representation of the source sequence.

In some embodiments, a gravcode representation of a source sequence may be used. Assume that M=2^{B} for some non-negative integer B. The graycoded representation of a source symbol sᵢ is a length B=log₂| [symbol] | sequence of binary digits

$${z}_{i}^{B} = ( {z}_{i , 1} , {z}_{i , 2} , … , {z}_{i , B} ) {=}^{Δ} {t}_{\vert 𝒮 \vert \to 2} ( {s}_{i} ) , \qquad ( 54 )$$

where [symbol] : [symbol] →{0,1}^{B} is the translator function that maps symbols over [symbol] to B-tuple strings over {0,1}. Another translator function [symbol] : ( [symbol] → [symbol] )→({0,1}→ [symbol] )^{B} can be defined that maps messages over [symbol] , [symbol] , to messages over {0,1}, m⁽²⁾,

$${T}_{\vert 𝒮 \vert \to 2} ( {m}^{( \vert 𝒮 \vert )} ) = ( {m}_{1}^{( 2 )} , … , {m}_{B}^{( 2 )} ) = {m}^{( 2 )} , \qquad ( 55 )$$

where each message

$${m}_{i}^{( 2 )}$$

is a 2-dimensional message over the alphabet {0,1}. Assuming that the messages are normalized probabilities, for ω∈{1, . . . , B} and β∈{0,1}

$${{T}_{\vert 𝒮 \vert \to 2} ( {m}^{( \vert 𝒮 \vert )} )}_{ω} ( β ) = {m}_{ω}^{( 2 )} ( β ) {=}^{Δ} {\sum }_{s ∈ 𝒮} {m}^{( \vert 𝒮 \vert )} ( s ) {1}_{\{ {t}_{\vert 𝒮 \vert \to 2} = β \}} . \qquad ( 56 )$$

The translation functions can be defined in the reverse direction in a similar manner.

$${t}_{2 \to \vert 𝒮 \vert} ( {z}_{i}^{B} ) {=}^{Δ} {\sum }_{j = 1}^{B} {2}^{B - j} {z}_{i , j} , \qquad ( 57 )$$

and for s∈

[symbol]

$${T}_{2 \to \vert 𝒮 \vert} ( {m}^{( 2 )} ) ( s ) = {\prod }_{ω = 1}^{B} {m}_{ω}^{( 2 )} ( {{t}_{\vert 𝒮 \vert \to 2} ( s )}_{ω} ) . \qquad ( 58 )$$

The translation equations state that [symbol] is a product of the marginals

$${m}_{1}^{( 2 )} , … {m}_{B}^{( 2 )}$$

appropriately indexed at the indices specified by

[symbol]

The graycode representation of a large alphabet symbol is sometimes used in lossless compression, specifically in run length encoding (RLE). The graycode transformation constrains large alphabet symbols with similar values to have bit representations with only a few bit flips. Consider the integer three with binary representation 011 and the integer four with binary representation 100. Though these numbers are similar, especially in the context of intensity of pixels, the binary representations are hard to compress due to three bit-flips. On the other hand, the graycode representations 010 and 110 for three and four respectively only differ by a single bit flip. Hence, graycodes are beneficial when using codes that leverage the differences in neighboring values.

If z is an integer and bin(z) is its binary representation, the graycode representation is obtained by the following transformation

$$gray ( z ) = x o r ( rightshift ( bin ( z ) , 1 ) , bin ( z ) ) . \qquad ( 59 )$$

In some cases, a decoder may not converge without some non-trivial initialization of the messages. To ensure that decoding converges, embodiments of the present disclosure can transmit a subset of the input source symbols uncompressed. This process is sometimes referred to as “doping.” Doping acts as a seed for the decoding algorithm and helps in reducing the solution set of possible source sequence corresponding to a codeword. The overall compression rate of the architecture can thus be expressed as

$${r}_{total} = {r}_{code} + {r}_{dope} . \qquad ( 60 )$$

FIG. 9 thus illustrates a model-code separation architecture for lossless compression of sources with arbitrary alphabet size. The decoding algorithm can follow the same procedure described above for FIG. 8, with an extra step to translate the messages according to equations (56) and (58) in controller 906.

### SPN-based Model-Code Separation Architecture

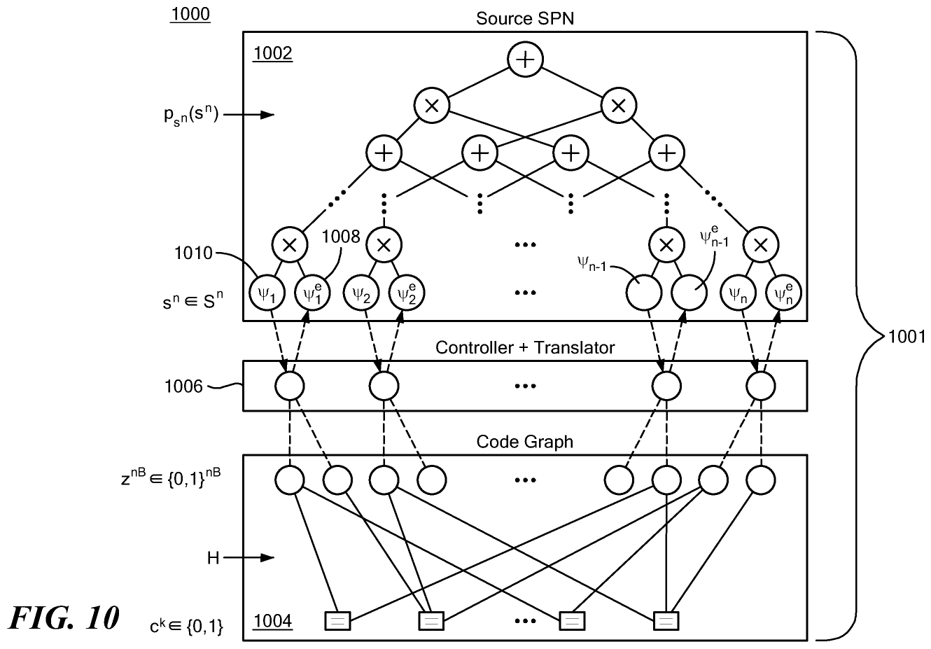

Turning to FIG. 10, embodiments of the present disclosure can employ an SPN source model within a model-code separation architecture. In some cases, a combined source-code decoder can make use of a DGCSPN, such as described above in the context of FIG. 5, as DGCSPN admits relatively efficient parameter learning using gradient descent. Other SPN architectures—such as the random tensorized SPN (RAT-SPN)—may also be employed, according to the general concepts, techniques, and structures sought to be protected herein.

For an input source sⁿ with sᵢ∈ [symbol] , assign one indicator leaf with singular scope for each source symbol,

$${ψ}_{i} ( s ) {=}^{Δ} {1}_{\{ {s}_{i} = s \}} . \qquad ( 61 )$$

Each sum and product node outputs S and P output channels respectively, with S typically equal to P. In some embodiments, channel sizes of 32, 64 or 128 may be used. In general, the channel size may be selected depending on the dataset being used. In some cases, models may be trained using the Adam optimizer with a learning rate between 0.01 and 0.1 depending on the source data.

FIG. 10 shows example of a combined SPN source-code decoder 1000 that can include or otherwise make use of combined graph 1001, formed from source SPN graph (or simply “SPN”) 1002 and code graph 1004, and a virtual controller 1006 having translation functionality. Decoder 1000 may correspond to decoder 704 of FIG. 7, for example.

Arrows between controller 1006 and SPN 1002 denote the direction of message flow. Messages from code graph 1004 are fed as external beliefs to SPN 1002 and hence they are multiplied with the leaf distributions (e.g., using the technique described above with FIG. 6. For example, external belief node 1008 can be multiplied by leaf distribution node 1010, as shown. Messages from source SPN graph 1002 can be accumulated from the gradients at the leaf nodes of the SPN and sent to controller 1006.

Messages sent from code graph 1004 to controller 1006 may be over the alphabet {0,1}. Hence, in some cases, a message may be translated before it is provided to the SPN 1002 as external beliefs. For a node u representing source symbol sᵤ, the external belief provided to the SPN is

$${ψ}_{u}^{e} ( {s}_{u} ) {=}^{Δ} {T}_{2 \to \vert 𝒮 \vert} ( {m}_{u \to u}^{c \to s} ) ( {s}_{u} ) . \qquad ( 62 )$$

To compute messages from SPN 1002 to code graph 1004, the marginals of all the leaf nodes of the SPN may be required. As previously discussed, to compute the marginal of a node sᵢ, all other leaf distributions must be fixed to unity, i.e., for all j≠i, ψⱼ=1. To obtain the marginals of all the nodes in parallel, embodiments of the present disclosure set ψᵢ=1 for all i∈{1, . . . , n}.

The marginals can be accumulated at the leaf distribution nodes (e.g., node 1010), hence the arrow points from the leaf distribution to the controller. Although the external beliefs are represented as nodes in FIG. 10 (e.g., node 1008), they can be interpreted and implemented as virtual connections, according to some embodiments. The marginals from the SPN 1002 are sent to controller 1006 for translation. Code graph 1004 can use the translated messages for code graph BP.

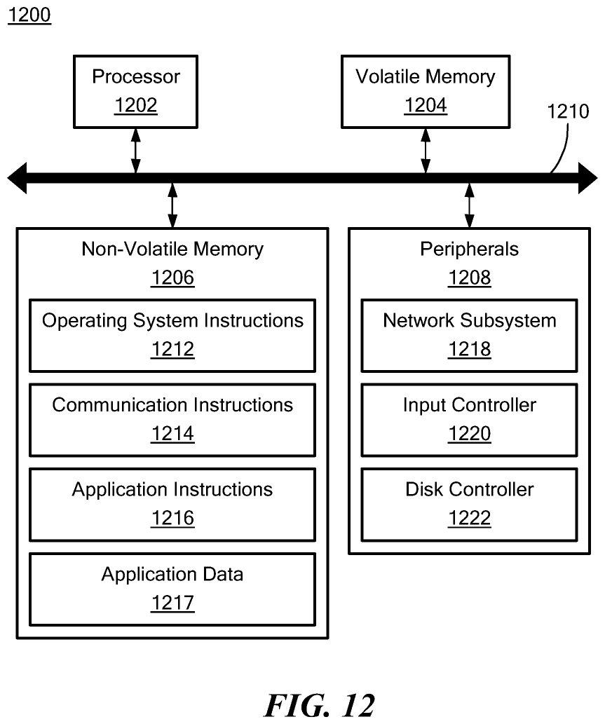

Algorithm 2 shows an example of a decoding algorithm that runs BP with an SPN-based source model. The algorithm, which may be referred to as “SPN source-code belief propagation,” can be implemented within and/or utilized by a decoder in a model-code separation system or architecture, such as system 700 of FIG. 7. In some cases, Algorithm 2 may be implemented on a computing device such as that described below in the context of FIG. 12.

Algorithm 2: SPN source-code belief propagation (BP).

```
Data: SPN Φ, code graph [symbol]  = ( [symbol]  , [symbol]   , [symbol]   ),
$doped symbols {S}_{𝒟}^{n} .$
Result: Decoded source sequence sⁿ.
/ * Initialize messages between source and code graphs. * /
${m}^{s \to c} ← 1 ; {m}^{c \to s} ← \frac{1}{2} 1 ;$
/* Start iterative decoding. * /
T ← 0;
repeat
  T ← T + 1;
  /* Code Graph Belief-Propagation. * /
  1. Receive beliefs sent to the controller from the SPN and translate them
    for code graph BP, [symbol]
(m^{s→c}).
  2. Assimilate the beliefs from SPN as extra factor nodes and run BP on
    code graph.
  3. Return new beliefs to the controller,
m^{s→c};
  /* Parallel Marginal Computation in SPN. * /
  1. Set all leaf node distributions to unity,
ψᵤ = 1 for all u.
  2. Receive beliefs sent to the controller from the code graph, translate
    them for inclusion as external beliefs,
${ψ}_{u}^{e} {=}^{Δ} ( {m}^{c \to s} ) .$
  3. Run a forward pass of the SPN from leaves to root.
  4. Compute all marginals in parallel according to (44). Replace doped
    sites with indicator distributions. Send to the controller as new
    messages,
m^{s→c}.
  /* Compute unnormalized probabilities over S */
${b}_{u} ← {m}_{u \to u}^{s \to c} ( {m}_{u \to u}^{c \to s} ) for all u ;$
until unnormalized probabilities converge
/* Get decoded source sequence */
ŝᵤ = arg [symbol]  bᵤ(s).
return ŝⁿ.
```

Model-code separation systems and architectures with SPNs can provide various benefits. For example, a model-code separation architecture only requires the source sequence to have a bit-level representation in order to compress it. Moreover, by using an LDPC parity-check matrix, the code has low complexity and is agnostic of the source modality.

As another benefit, since the encoder has no knowledge of the source, the decoder requires knowledge about the source to accurately decode the source sequence, of which there can be many for a given codeword. The source data model can be swapped out easily in the decoder, for example, when knowledge of the source changes. SPNs can learn powerful statistical structure from large datasets and can losslessly compress natural images, a task which proved tough for PGMs due to their simple structure.

As another benefit, by using an SPN as a source model, complex distributions can be represented using deep DAGs implemented efficiently through convolutions. Parameter learning is relatively easy with SPNs and hence the same SPN architecture can be used with different parameters to model a variety of complex distributions.

As another benefit, the encoder, source graph, code graph and translator are all disjoint components. Hence, a change to one of these will not require significant changes to other components. This allows the code to be easily changed. For example, to use a code other than an LDPC code, only the parity-check matrix needs to be switched out in the encoder. The code graph can easily be updated to model different coding constraints by updating the factor nodes.

As another benefit, SPNs can compute all marginals in parallel. Even though an SPN has an underlying DAG much larger than that of a typical PGM, inference is extremely fast and most importantly tractable. The SPN-based architecture can be efficiently implemented on fast inference engines such as GPUs with SPN-based architectures demonstrating decoding times under 0.05 seconds, much faster than a PGM-based architecture implemented on a GPU.

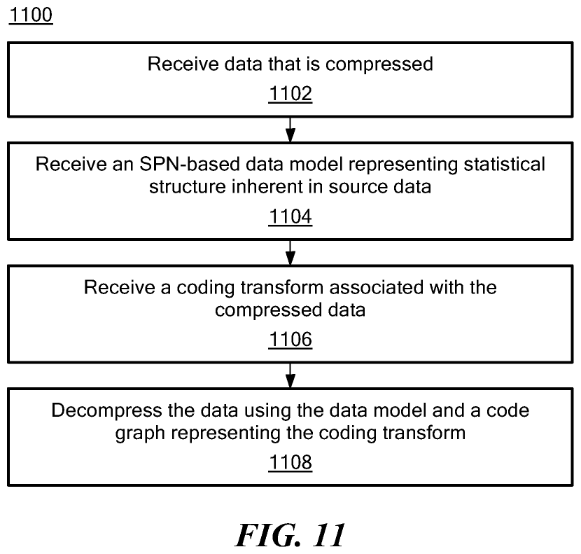

FIG. 11 shows an example of a process 1100 for decompressing data that may be used with model-code separation systems and architectures. For example, process 1100 may be implemented within and/or executed by decoder 704 of FIG. 7 in the form computer software or firmware.

At block 1102, data that is compressed may be received. In some cases, the data may be data encoding using a universal encoder (e.g., using an LDPC code).

At block 1104, a data model representing statistical structure inherent in source data may also be received (i.e., source data corresponding to an uncompressed version of the data received at block 1102). The data model may be based on an SPN or, more particularly, based on a DGCSPN.

At block 1106, a coding transform associated with the compressed data may also be received. In the case where the data is encoding using an LDPC code, the coding transform may be an LDPC parity-check matrix H.

In some cases, some or all of the information received at blocks 1102, 1104, and 1106 may be received by a decoder via a computer network or from computer storage. In some cases, the compressed data and/or the coding transform may be generated by and received from an encoder (e.g., encoder 702 in FIG. 7). In some cases, the encoder may be a model-free encoder and, thus, the data model may be received from a separate source. For example, a user or process other than the encoder may generate a mapping between input symbols and codewords that takes into account the relative frequency of the incoming symbols and provide this mapping to the decoder.

At block 1108, the data can be decompressed using the data model and a code graph (e.g., a Tanner graph) representing the coding coefficients. In some cases, the decompression can operate over a combined graph generated from the data model, the code graph, and a virtual controller having nodes representing symbols in a source sequence of the decompressed data. In some cases, BP may be run on the combined graph to compute approximate marginals of the source sequence that satisfies constraints of both the SPN and the code graph. In some cases, this can more particularly include passing, by the virtual controller, statistical information between the code graph and the SPN-based mode. In some cases, the statistical information may be defined over a binary alphabet and, thus, the process can further include translating, by the virtual controller, the statistical information from the binary alphabet to an alphabet over which the compressed data is defined. In some cases, the decompression can more particularly include any or all of the steps of Algorithm 2 described in detail above.

Process 1100 can be used for lossless and/or lossy data decompression. Various other features and concepts disclosed herein can be incorporated into process 1100.

FIG. 12 shows an illustrative computing device 1200 that may implement various features and processes as described. The computing device 1200 may be implemented on any electronic device that runs software applications derived from compiled instructions, including without limitation personal computers, servers, smart phones, media players, electronic tablets, game consoles, email devices, etc. In some implementations, the computing device 1200 may include one or more processors 1202. volatile memory 1204, non-volatile memory 1206, and one or more peripherals 1208. These components may be interconnected by one or more computer buses 1210.

Processor(s) 1202 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Bus 1210 may be any known internal or external bus technology, including but not limited to ISA, EISA, PCI, PCI Express, NuBus, USB, Serial ATA or FireWire. Volatile memory 1204 may include, for example, SDRAM. Processor 1202 may receive instructions and data from a read-only memory or a random-access memory or both. The essential elements of a computer may include a processor for executing instructions and one or more memories for storing instructions and data.

Non-volatile memory 1206 may include by way of example semiconductor memory devices, such as EPROM. EEPROM, and flash memory devices; magnetic disks such as internal hard disks and removable disks; magneto-optical disks; and CD-ROM and DVD-ROM disks. Non-volatile memory 1206 may store various computer instructions including operating system instructions 1212, communication instructions 1214, application instructions 1216, and application data 1217. Operating system instructions 1212 may include instructions for implementing an operating system (e.g., Mac OS®, Windows®, or Linux). The operating system may be multi-user, multiprocessing, multitasking, multithreading, real-time, and the like. Communication instructions 1214 may include network communications instructions, for example, software for implementing communication protocols, such as TCP/IP, HTTP, Ethernet, telephony, etc.

Peripherals 1208 may be included within the computing device 1200 or operatively coupled to communicate with the computing device 1200. Peripherals 1208 may include, for example, network interfaces 1218, input devices 1220, and storage devices 1222. Network interfaces may include for example an Ethernet or Wi-Fi adapter. Input devices 1220 may be any known input device technology, including but not limited to a keyboard (including a virtual keyboard), mouse, trackball, and touch-sensitive pad or display. Storage devices 1222 may include one or more mass storage devices for storing data files; such devices include magnetic disks, such as internal hard disks and removable disks; magneto-optical disks; and optical disks.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate. The program logic may be run on a physical or virtual processor. The program logic may be run across one or more physical or virtual processors.

The subject matter described herein can be implemented in digital electronic circuitry, or in computer software, firmware, or hardware, including the structural means disclosed herein and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal. for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component. subroutine, or another unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this disclosure, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by ways of example semiconductor memory devices, such as EPROM, EEPROM, flash memory device, or magnetic disks. The processor and the memory can be supplemented by, or incorporated in, special purpose logic circuitry.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A method of decoding data, the method comprising:
receiving data compressed by a universal encoder and a data model based on a sum-product network (SPN) representing statistical structure inherent to source data, the source data corresponding to an uncompressed version of the data; and
decompressing the data using the data model.

2. The method of claim 1 further comprising:
receive a coding transform associated with the compressed data; and
generating a code graph representing the coding transform,
wherein the decompressing of the data uses both the data model and the code graph.

3. The method of claim 2 further comprising:
generating a combined graph having the data model, the code graph, and a virtual controller having nodes representing symbols in a sequence of the source data,
wherein the decompressing of the data uses the combined graph.

4. The method of claim 3 wherein the decompressing of the data includes:
running belief propagation (BP) on the combined graph to compute approximate marginals of the source data sequence that satisfies constraints of both the data model and the code graph.

5. The method of claim 4 wherein the running of BP on the combined graph includes:
passing, by the virtual controller, statistical information between the code graph and the data model.

6. The method of claim 5 wherein the statistical information is defined over a binary alphabet, the method further comprising:
translating, by the virtual controller, the statistical information from the binary alphabet to an alphabet over which the compressed data is defined.

7. The method of claim 1 wherein the decompressing of the data includes losslessly recovering the source data.

8. The method of claim 1 wherein the decompressing of the data includes lossily recovering the source data.

9. The method of claim 1 wherein the data model is based on a deep generalized convolutional SPN (DGCSPN).

10. A decoder for use in a data compression system with model-code separation, the decoder comprising:
one or more processors configured to:
receive data compressed by a universal encoder and a data model based on a sum-product network (SPN) representing statistical structure inherent to source data, the source data corresponding to an uncompressed version of the data; and
decompress the data using the data model.

11. The decoder of claim 10 wherein the one or more processors are further configured to:
receive a coding transform associated with the compressed data; and
generate a code graph representing the coding transform,
wherein the decompressing of the data uses both the data model and the code graph.

12. The decoder of claim 11 wherein the one or more processors are further configured to:
generate a combined graph having the data model, the code graph, and a virtual controller having nodes representing symbols in a sequence of the source data,
wherein the decompressing of the data uses the combined graph.

13. The decoder of claim 12 wherein the decompressing of the data includes:
running belief propagation (BP) on the combined graph to compute approximate marginals of the source data sequence that satisfies constraints of both the data model and the code graph.

14. The decoder of claim 13 wherein the running of BP on the combined graph includes:
passing, by the virtual controller, statistical information between the code graph and the data model.

15. The decoder of claim 14 wherein the statistical information is defined over a binary alphabet, wherein the one or more processors are further configured to:
translate, by the virtual controller, the statistical information from the binary alphabet to an alphabet over which the source data is defined.

16. The decoder of claim 10 wherein the decompressing of the data includes losslessly recovering the source data.

17. The decoder of claim 10 wherein the decompressing of the data includes lossily recovering the source data.

18. The decoder of claim 10 wherein the data model is based on a deep generalized convolutional SPN (DGCSPN).
